(19) United States
(12) Patent Application Publication
(10) Pub. No.: US 2012/0279336 A1
(43) Pub. Date: Nov. 8, 2012

(54) TRANSMISSION DRIVE UNIT

(75) Inventors: Hans-Peter Dommsch, Lichtenau (DE); Peter Bohr, Karlsruhe (DE); Martin Wiesler, Baden-Baden/Neuweier (DE)

(73) Assignee: ROBERT BOSCH GMBH, Stuttgart (DE)

(21) Appl. No.: 13/504,976

(22) PCT Filed: Aug. 30, 2010
(86) PCT No.: PCT/EP2010/062605

§ 371 Date: Jul. 23, 2012

(30) Foreign Application Priority Data
Oct. 28, 2009 (DE) 102009046080

(51) Int. Cl. F16D 41/20

(52) U.S. Cl. 74/411.5

(57) ABSTRACT

The invention relates to a transmission drive unit (10), comprising a transmission element (11) that is rotatably arranged on the drive side in a transmission housing (15), with which transmission element a driving torque can be transmitted to at least one guiding element (25, 26) of a coupling element (20) on the output side, and a load torque lock, with which a torque introduced by the output-side coupling element (20) via the at least one guiding element (25, 26) can be locked, wherein the load torque lock comprises a locking element (42) that is preferably designed as wrap spring that cooperates with a brake element (34; 34a; 34b), which comprises a friction surface (51) and is arranged non-rotatably in the transmission housing (15), for locking the torque. According to the invention, the brake element (34; 34a; 34b) consists of a plurality of sheet metal elements (48, 49; 57, 58; 57b; 58b) and the sheet metal elements (48, 49; 57, 58; 57b; 58b) are connected to each other.

### BACKGROUND OF THE INVENTION

The invention relates to a transmission drive unit.

A transmission drive unit is known from DE 10 2005 012 938 A1. In the case of the known transmission drive unit embodied as a power window actuator a wrap spring is arranged in a section of a hollow shaft, which section is used as a brake element. A brake element of this type is also described as a brake drum. In order to manufacture a brake drum of this type, it is known from the prior art that this is embodied either as a turned part, as a deep-drawn part or as a roller-burnished part. However, all these methods have specific disadvantages. For example, when manufacturing the part as a turned part, a relatively cost-intensive manufacturing process is required. If the part is embodied as a deep-drawn part or a roller-burnished part, it is on the other hand relatively difficult to maintain the required tolerances, so that the latter manufacturing method often requires a mechanical reworking of the friction surface, which further increases the manufacturing costs.

### SUMMARY OF THE INVENTION

Based on the illustrated prior art, the object of the invention is to develop a transmission drive unit in such a way that its brake element can be manufactured in a cost-effective manner whilst simultaneously maintaining a high level of accuracy. This object is achieved in the case of a transmission drive unit according to the invention. The invention is based on the idea of embodying the brake element from a plurality of mutually connected sheet metal elements. Sheet metal elements of this type have the advantage that they can be manufactured in a relatively cost-effective manner with a high level of accuracy, so that a brake element assembled from the sheet metal elements when seen as a whole can likewise be manufactured in a relatively cost-effective manner and simultaneously comprises the required tolerances or rather accuracies. In addition, the modular construction provides the advantage of being able to change the size of the brake element at a relatively low cost.

In a particular advantageous embodiment of the invention, it is provided that the brake element is embodied in the shape of a sleeve, that the sheet metal elements are embodied in an annular manner and that the sheet metal elements are stacked one above the other as seen in the longitudinal direction of the brake element. This has the advantage that, for example, fastening elements for the brake element can be produced in a simple manner by virtue of the fact that the required fastening elements are embodied as one on individual sheet metal rings. In addition, an embodiment of this type offers the advantage that the height of the brake element can be adapted in a particularly simple manner to suit the respective overall size of the transmission drive unit, in that the brake element is assembled from more or fewer sheet metal rings.

As an alternative thereto, it is provided in a different structural embodiment of the invention that the brake element is embodied in the shape of a sleeve and that the sheet metal elements are embodied as curved sleeve segments. This embodiment has the advantage that the brake element viewed as a whole is assembled from relatively few components, which is advantageous with respect to the connection of individual components and the surface characteristic, in particular of the friction surface.

In the case of the latter embodiment of the invention, it can be provided in particular that the sheet metal elements are mutually connected in a positive-locking manner. As a consequence, a relatively cost-effective assembly process is possible, which in addition prevents, for example, distortion as a result of the process of welding individual sheet metal elements.

The individual sheet metal elements can be manufactured in a particularly cost-effective manner if these are embodied as stamped sheet metal parts.

In addition, it can be advantageous for connecting the individual sheet metal elements to mutually connect said elements by means of at least one weld seam. The weld seam forms a connection by material-engagement between the individual sheet metal elements and renders possible an extremely high level of strength.

It is particularly advantageous in this case if the weld seam is arranged on a side of the sheet metal elements, which side lies opposite to the friction surface. As a consequence, in particular it is not necessary to rework the friction surface in a mechanical manner and this reduces the manufacturing costs.

Alternatively or in addition, it is, however, also feasible to mutually connect the individual sheet metal elements in a non-positive manner by means of at least one separate connecting element. A non-positive connection of this type, which, for example, can be embodied with the aid of one or a plurality of connecting pins, creates either an inner connection between the individual sheet metal elements or it is used merely to fasten the sheet metal elements, so that they lie, for example, during the welding process in their correct position.

In particular it can also be provided that the friction surface is reworked mechanically in order to achieve a required surface characteristic or dimensional stability of the friction surface. However, the cost of the mechanical reworking is relatively low by virtue of the construction in accordance with the invention using sheet metal elements, so that this processing step can be implemented in a relatively cost-effective manner.

### BRIEF DESCRIPTION OF THE DRAWINGS

Further advantages of the transmission drive unit in accordance with the invention are disclosed in the following description of preferred exemplary embodiments and with reference to the drawings, in which:

FIG. 1 shows an exploded illustration of a transmission drive unit in accordance with the invention,

FIG. 2 shows a longitudinal cross-sectional view through the assembled transmission drive unit in accordance with FIG. 1,

FIG. 3 shows a perspective view of a brake drum comprising a plurality of sheet metal rings stacked one on top of the other,

FIG. 4 shows a perspective view of a brake drum assembled from a plurality of arcuate sheet metal segments, wherein the sheet metal segments are mutually connected by virtue of a positive closure and

FIG. 5 likewise shows a perspective view of a brake drum that has been modified with respect to the brake drum shown in FIG. 4 and wherein the individual sheet metal segments are mutually connected by means of weld connections.

### DETAILED DESCRIPTION

Like components or parts having a like function are provided in the figures with identical reference numerals.

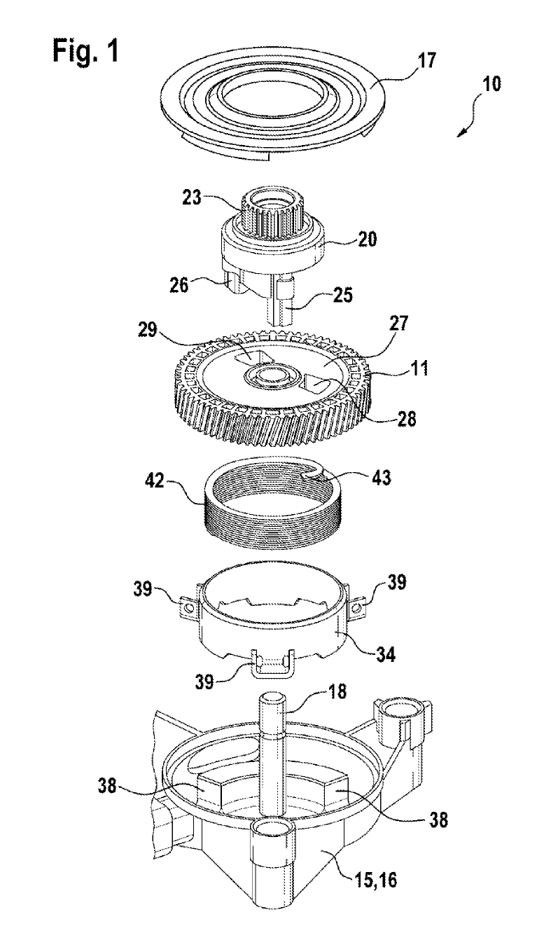

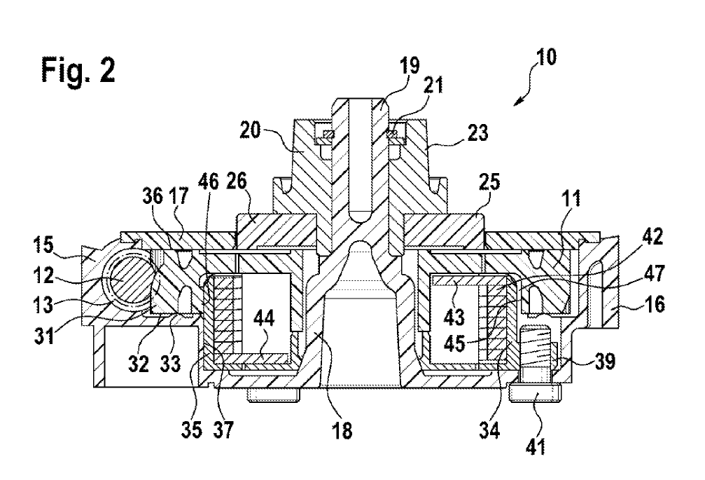

FIGS. 1 and 2 illustrate a transmission drive unit 10 for an adjustment drive in a motor vehicle. The exemplary embodiment is described with reference to a power window actuator. However, it is explicitly within the scope of the invention that a transmission drive unit 10 of this type is feasible for any auxiliary unit and for any unit that adds to the convenience of operation in a motor vehicle, e.g. for sunroof actuators, seat adjusters, windscreen wipers, transmission and clutch regulators, power steering systems, servo drives or other applications. The type of electrically operated drive motors used is also independent of the following description and is to be adapted to the respective application.

The transmission drive unit 10 comprises a transmission element embodied from a synthetic material as an inclined-tooth driven gear that is described hereinunder as a spur gear 11. The spur gear 11 is driven by an electric motor [not illustrated], such as is illustrated in DE 10 2005 012 938 A1. The electric motor comprises for this purpose a drive shaft 12 having a likewise inclined-tooth gear wheel 13 that meshes with the outer toothing of the spur gear 11. The spur gear 11 is accommodated in a transmission housing 15 of the transmission drive unit 10, said transmission housing being made from a synthetic material.

The transmission housing 15 comprises a cup-shaped base part 16 and a housing cover 17 that is arranged on the upper face of the base part 16. The housing cover 17 is embodied in an annular manner and can latch with the base part 16 in particular by means of a positive closure. A bearing spigot 18 whose one end 19 protrudes out of the housing cover 17 is formed as one piece on the transmission housing 15. An output element 20 is rotatably mounted on the bearing spigot 18. The output element 20 is secured in an axial manner on the bearing spigot 18 by means of a shaft clamping ring 21.

The output element 20 comprises on the side facing out from the housing cover 17 a toothing arrangement 23 by means of which the driving torque of the electric motor can be transmitted to the mechanics or kinematics (not illustrated in detail) of a window actuator, whereby a window pane as a moving part is adjusted. In addition, the output element 20 comprises two guiding elements 25, 26 that extend in parallel and at a spaced disposition with respect to the bearing spigot 18, said guiding elements protruding into the inside of the transmission housing 15. Two cut-outs 28, 29 are embodied for this purpose in the disk-shaped upper face 27 of the spur gear 11 (FIG. 1).

The spur gear 11 is axially positioned or rather mounted with its toothed ring 31 in the transmission housing 15. By way of example and therefore not limiting, the lower face 32 of the toothed ring 31 lies for this purpose on an annular base area 33 of the base part 16 of the transmission housing 15. The upper face 36 of the toothed ring 31 is in turn arranged in an operative connection with the housing cover 17.

A brake drum 34 made from metal is arranged in the transmission housing 15 and partly within the toothed ring 31 and on the side facing out from the housing cover 17. The brake drum 34 that is embodied substantially in the shape of a sleeve or cup lies with the part of its outer wall 35 that is located beneath the spur gear 11 on a cylindrical wall 37 of the base part 16. The wall 37 in the base part 16 comprises in addition a plurality of cut-outs 38, into which engage in a positive-locking manner the fastening brackets 39 of the brake drum 34. The fastening brackets 39 of the brake drum 34 can be fastened by means of fastening screws 41 by way of through-going bores embodied in the lower face of the base part 16.

A locking element that is embodied as a wrap spring 42 and functions as a load torque lock is arranged inside the brake drum 34. The wrap spring 42 comprises two ends 43, 44 that protrude radially inwards and cooperate with the guiding elements 25, 26 of the output element 20. The wrap spring 42 takes up almost the entire height of the wall 35 of the brake drum 34 and is arranged in a radial manner at only a small spaced disposition with respect to the inner face of the wall 35, so that the wall 35 on its inner face is used as a mounting for the wrap spring 42.

It is provided in the case of the illustrated exemplary embodiment that the wall 35 of the brake drum 34 is not used only to receive or mount the wrap spring 42 but rather also for radially mounting the spur gear 11. It is provided for this purpose that a plurality of mounting ribs 46 that are arranged in uniform angular spaced dispositions with respect to each other are embodied on the circumferential inner face 45 of the toothed ring 31 of the spur gear 11. The bearing ribs 46 cooperate in so doing with the region of the wall 35 of the brake drum 34 located above the base region 32 of the base body 16, in that the bearing ribs 46 lie on the outer face of the wall 35 or rather are at a spaced disposition thereto with a minimum amount of clearance.

The bearing ribs 46 that extend in the longitudinal direction are preferably formed as one piece on the inner face 45, which in the case of a spur gear 11 embodied as an injection molded part can be achieved in a cost-effective manner. In the regions in which there are no bearing ribs 46, annular gaps 47 are embodied between the spur gear 11 and the brake drum 34.

During the operation of the transmission drive unit 10, a torque introduced by the electric motor by way of the drive shaft 12 is transmitted as already described by way of the spur gear 11 and the guiding elements 25, 26 to the output element 20. If a torque is now introduced into the transmission drive unit 10 by way of the output element 20, then the ends 43, 44 of the wrap spring 42, which ends are arranged in an operative connection with the guiding elements 25, 26, cause the wrap spring 42 to widen in diameter and to lie on the inner surface of the wall 35 of the brake drum 34. As a consequence, the movement of the guiding elements 25, 26 is stopped, which guiding elements are connected by way of the cut-outs 28, 29 for their part to the spur gear 11.

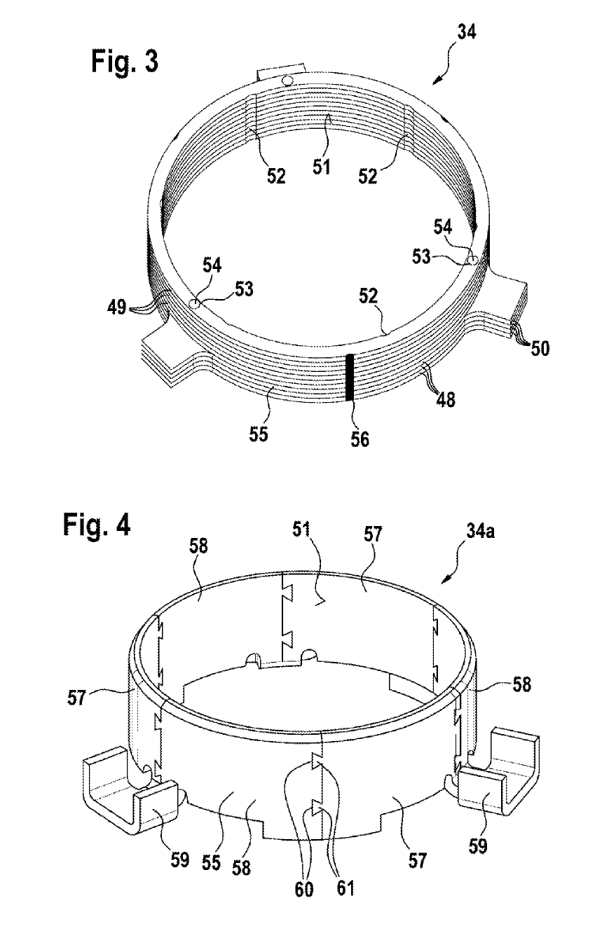

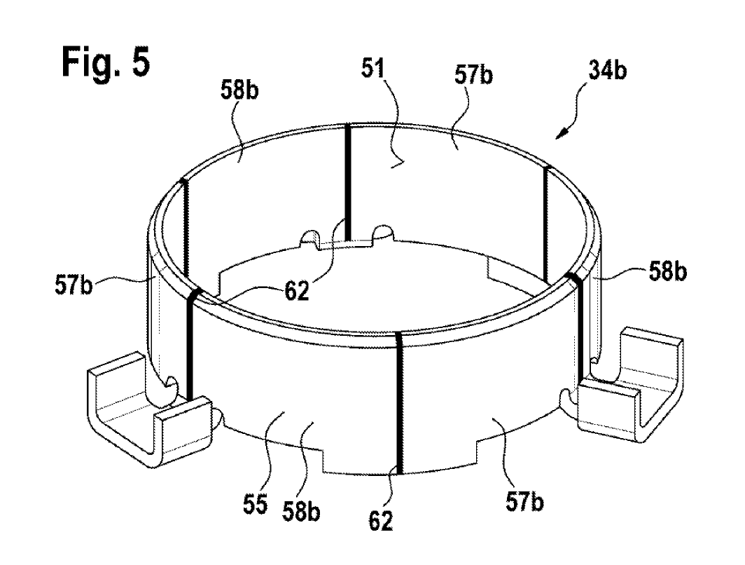

Essential for the invention is the embodiment explained hereinunder in further detail or rather the design of the brake drum 34, 34a and 34b as explained hereinunder in further detail with reference to FIGS. 3 and 5.

FIG. 3 illustrates a first embodiment of the brake drum 34, wherein said brake drum is embodied from a number of sheet metal segments 48, 49 that are in each case annular and are stacked one above the other as seen in the longitudinal direction of the brake drum 34. The sheet metal segments 48 and 49 are each manufactured as stamped parts. The sheet metal segments 48 comprise in addition integral fastening brackets 50, while the sheet metal segments 49 are embodied in a circular manner on their outer periphery. In addition, a plurality of lubrication grooves 52 are embodied or arranged in the longitudinal direction on the inner surface of the brake drum 34, which inner surface functions as a friction surface 51 for the wrap spring 46. The lubrication grooves 52 are taken into consideration either initially during stamping with the dimensions of the sheet metal segments 48 and 49 or they are subsequently provided in the brake drum 34 by virtue of a corresponding mechanical process.

The connection between the individual sheet metal segments 48 and 49 can be achieved in numerous ways, wherein in the exemplary embodiment illustrated in FIG. 3 the sheet metal segments 48 and 49 comprise on the one hand through-going cut-outs 53 which are aligned with each other in the longitudinal direction of the brake drum 34, into which through-going cut-outs are pressed pin-shaped connecting elements 54. In so doing, it is feasible that the connecting elements 54 alone create the connection between the sheet metal segments 48 and 49. Alternatively or in addition, it can, however, also be provided that weld seams 56 that extend in the longitudinal direction of the brake drum 34 are embodied on the outer wall 55 of the brake drum 34 or rather on the sheet metal segments 48 and 49. In so doing, it is preferably provided that the weld seams 56 are arranged in uniform angular spaced dispositions with respect to each other in order to prevent the sheet metal segments 48, 49 from distorting owing to the irregular heat input.

A modified brake drum 34a is illustrated in FIG. 4. The brake drum 34a likewise comprises a plurality of sheet metal segments 57, 58, wherein the sheet metal segments 57 and 58, however, are embodied as curved sleeve segments. These are manufactured by virtue of the fact that they are initially stamped out from a corresponding sheet metal blank and subsequently rolled, i.e. are provided with the corresponding curvature. In addition, in the case of the sheet metal segments 57, fastening brackets 59 are embodied as one thereon and are formed by virtue of a corresponding shaping process during the process of manufacturing the sheet metal segments 57. The sheet metal segments 57 and 58 are mutually connected by virtue of a positive-locking connection. In so doing, cut-outs 60 are embodied in the sheet metal segments 58 and said cut-outs cooperate with corresponding swallow tail-like protrusions 61 in the sheet metal segments 58 [sic].

In the case of the brake drum 34b illustrated in FIG. 5 that has been modified with respect to the brake drum shown in FIG. 4, the connection between the sheet metal segments 57b and 58b is embodied in each case by virtue of a corresponding weld seam 62 that extends in the longitudinal direction.

In order to achieve a required dimensional stability or a required surface characteristic of the friction surfaces 51 on the brake drums 34, 34a and 34b, it can be necessary to rework the friction surfaces 51 mechanically. This can be achieved, for example, by turning or by polishing. In particular in association with the transmission drive unit 10 illustrated in FIGS. 1 and wherein the brake drum 34 or rather its outer face is used simultaneously as a bearing element for the spur gear 11, it can also be necessary to work the outer wall 55 of the brake drum 34, 34a or 34b accordingly.

In addition, it is also mentioned that the transmission drive unit 10 described can be modified in various ways. Thus, for example, it is not necessary for the transmission drive unit to comprise a wrap spring 42. Only the design or the embodiment of a brake drum 34, 34a or 34b comprising a friction surface 51 by means of sheet metal segments is essential for the invention.

1. A transmission drive unit (10) having a drive-side transmission element (11) that is rotatably arranged in a transmission housing (15), with which transmission element a driving torque can be transmitted to at least one guiding element (25, 26) of an output-side coupling element (20) and having a load torque lock with which a torque introduced by the output-side coupling element (20) by way of at least one guiding element (25, 26) can be locked, wherein the load torque lock comprises a locking element (42), which locking element for the purpose of locking the torque cooperates with a brake element (34; 34a; 34b) that comprises a friction surface (51) and is rotatably arranged in the transmission housing (15), characterized in that the brake element (34; 34a; 34b) comprises a plurality of sheet metal elements (48, 49; 57, 58; 57b; 58b) and that the sheet metal elements (48, 49; 57, 58; 57b; 58b) are mutually connected.

2. The transmission drive unit as claimed in claim 1, characterized in that the brake element (34) is embodied in the shape of a sleeve, that the sheet metal elements (48, 49) are embodied in an annular manner and that the sheet metal elements (48, 49) are stacked one above the other as seen in a longitudinal direction of the brake element (34).

3. The transmission drive unit as claimed in claim 1, characterized in that the brake element (34a; 34b) is embodied in the shape of a sleeve and that the sheet metal elements (57, 58; 57b, 58b) are embodied as curved sleeve segments.

4. The transmission drive unit as claimed in claim 3, characterized in that the sheet metal elements (57, 58) are mutually connected in a positive-locking manner.

5. The transmission drive unit as claimed in claim 1, characterized in that the sheet metal elements (57, 58; 57b 58b) are embodied as stamped sheet metal elements.

6. The transmission drive unit as claimed in claim 1, characterized in that the sheet metal elements (48, 49; 57b, 58b) are mutually connected by virtue of at least one weld seam (56; 62).

7. The transmission drive unit as claimed in claim 6, characterized in that the at least one weld seam (56; 62) is arranged on a side of the sheet metal elements (48, 49; 57, 58b), which side lies opposite to a friction surface (51).

8. The transmission drive unit as claimed in claim 1, characterized in that the sheet metal elements (48, 49) are mutually connected in a non-positive locking manner by virtue of at least one separate connecting element (54).

9. The transmission drive unit as claimed in claim 1, characterized in that the friction surface (51) is reworked mechanically in order to achieve a required surface characteristic or dimensional stability of the friction surface (51).

10. The transmission drive unit as claimed in claim 1, characterized in that an outer wall (55) that lies opposite to the friction surface (51) is mechanically reworked in order to achieve a required surface characteristic or dimensional stability of the outer wall (55).

11. The transmission drive unit as claimed in claim 1 wherein the locking element is a wrap spring.

12. The transmission drive unit as claimed in claim 4, characterized in that the sheet metal elements (57, 58; 57b 58b) are embodied as stamped sheet metal elements.

13. The transmission drive unit as claimed in claim 12, characterized in that the sheet metal elements (48, 49; 57b, 58b) are mutually connected by virtue of at least one weld seam (56; 62).

14. The transmission drive unit as claimed in claim 13, characterized in that the at least one weld seam (56; 62) is arranged on a side of the sheet metal elements (48, 49; 57, 58b), which side lies opposite to a friction surface (51).

15. The transmission drive unit as claimed in claim 14, characterized in that the sheet metal elements (48, 49) are mutually connected in a non-positive locking manner by virtue of at least one separate connecting element (54).

16. The transmission drive unit as claimed in claim 15, characterized in that the friction surface (51) is reworked mechanically in order to achieve a required surface characteristic or dimensional stability of the friction surface (51).

17. The transmission drive unit as claimed in claim 16, characterized in that an outer wall (55) that lies opposite to the friction surface (51) is mechanically reworked in order to achieve a required surface characteristic or dimensional stability of the outer wall (55).
